(19) United States
(12) Patent Application Publication
(10) Pub. No.: US 2024/0369592 A1
(43) Pub. Date: Nov. 7, 2024

(54) METHOD FOR ESTIMATING THE REFERENCE SPEED OF A VEHICLE FOR LIMIT CONDITIONS

(71) Applicant: Ford Global Technologies, LLC, Dearborn, MI (US)

(72) Inventors: Cyril Coerman, Leverkusen (DE); Alex Fischer, Monheim (DE); Georg Johann Maurer, Cologne (DE)

(73) Assignee: Ford Global Technologies, LLC, Dearborn, MI (US)

(21) Appl. No.: 18/608,588

(22) Filed: Mar. 18, 2024

(30) Foreign Application Priority Data
May 4, 2023 (DE) 102023111544.8

(51) Int. Cl. G01P 7/00; G01S 19/52; G06T 7/20

(52) U.S. Cl. CPC G01P 7/00; G01S 19/52; G06T 7/20; G06T 2207/20084; G06T 2207/30252

(57) ABSTRACT

The invention relates to a method (1) for estimating a true ground speed (VRef) of an electrically drivable land vehicle by method of the vehicle's own evaluation electronics. In order to improve the estimation of the true speed (VRef), in particular in limit situations with restricted vehicle handling, a first speed value (V1) is determined taking into account an instantaneous wheel speed of at least one vehicle wheel of the land vehicle, a second speed value (V2) is determined taking into account a longitudinal acceleration of the land vehicle, a third speed value (V3) is determined taking into account received GPS data and a fourth speed value (V4) is determined taking into account camera data from a camera of the land vehicle, the true speed (VRef) being estimated taking into account these speed values (V1 to V4).

### CROSS-REFERENCE TO RELATED APPLICATIONS

The application herein asserts priority to and incorporates by reference German Application No. 102023111544.8, filed on May 4, 2023.

### FIELD OF THE INVENTION

The invention relates to a method for estimating a reference speed of a vehicle.

### BACKGROUND

In order to operate an anti-lock braking system (ABS) and a traction control system (TCS), it is necessary to know the driving speed of a correspondingly equipped land vehicle. Traditionally, a reference speed, which is based on the land vehicle driving straight ahead, is determined from vehicle data provided via a CAN bus of the land vehicle. However, in borderline situations, i.e. in borderline areas when the wheels have a high slip, i.e. a high slip ratio, which can occur on any surface, wherein the lower the friction, the greater the tendency to high slip, the vehicle data provided via the CAN bus generally does not provide accurate information, especially in order to optimally support a selected drive control in an electrically drivable land vehicle and to optimally utilize the potential of an electric drive of the land vehicle.

CN 109 872 415 B discloses a method based on an artificial neural network for estimating a vehicle speed. The method comprises obtaining training patterns and training outputs, and expanding the training input in the training pattern into a symmetric 8×8 real-time vehicle data matrix, with both the training output and the training input being in the form of vectors. Then, the convolutional artificial neural network is trained according to the symmetric real-time vehicle data matrix and the training output. Lastly, the real-time data of the actual vehicle is obtained and input into a retraining. In the convolutional artificial neural network, the lateral velocity and longitudinal velocity of the vehicle over ground are estimated.

CN 112 758 097 A discloses a state prediction and estimation method for an autonomous vehicle. The method comprises using a provided vehicle torque correction speed prediction formula, determining optimal parameters of the speed prediction formula by the characteristics of acceleration, acceleration derivative and the like, performing training by an artificial neural network, introducing data of a current driving state of a vehicle for updating and optimizing the acceleration and a temporal acceleration derivative, fusing a kinematics method and a dynamics method for estimating a road gradient, using a least squares method for estimating the vehicle mass, and improving the estimation accuracy of the vehicle mass and the sprung mass. Further, estimating the vertical force of the wheels using an information fusion method, introducing a road adhesion coefficient, and performing a joint estimation of a lateral force and the state of the vehicle using a nonlinear estimation method. Lastly, a vehicle rolling condition estimation method is provided in which variable vehicle parameters and variable working conditions are introduced and the accuracy of the vehicle speed prediction is improved with the variable vehicle parameters and the variable working conditions.

DE 10 2019 206 875 B3 discloses a method for detecting a motor vehicle driving on a verge, wherein at least one measured variable is detected by means of at least one sensor unit of the motor vehicle, wherein a first control value, which relates to a wheel movement of a wheel of the motor vehicle, is determined by means of a computing unit of the motor vehicle based on the at least one measured variable, wherein a second control value, which relates to a vehicle state variable dependent on a speed of the motor vehicle, is determined based on the at least one measured variable, wherein based on a comparison of the first control value with a first limit value, a first confidence value is determined for the presence of driving on a verge, wherein based on a comparison of the second control value with a second limit value, a second confidence value is determined for the presence of driving on a verge, wherein based on the first and the second confidence value an overall confidence value is determined for the presence of driving on a verge, wherein the at least one measured variable includes a wheel speed of the wheel, and wherein the first control value is determined in dependence on the wheel speed such that it relates to a vertical wheel movement of the wheel.

DE 10 2007 037 209 A1 discloses a method for vehicle control, wherein a yaw rate is determined by means of a yaw rate sensor, a pitch rate is determined by means of a pitch rate sensor, a lateral acceleration is determined by means of a lateral acceleration sensor, a vehicle speed is determined by means of a vehicle speed sensor, and a stability control system for providing yaw stability control is controlled in response to the yaw rate, the pitch rate, the lateral acceleration and the vehicle speed.

### SUMMARY

The invention is based on the object of improving an estimation of a ground reference speed of a land vehicle, in particular an electrically drivable land vehicle, in particular in borderline situations.

According to the invention, the object is achieved by a method having the features of the claims, according to which a first speed value is determined taking into account an instantaneous wheel speed of at least one vehicle wheel of the land vehicle, a second speed value is determined taking into account a longitudinal acceleration of the land vehicle, a third speed value is determined taking into account received GPS data and a fourth speed value is determined taking into account camera data of a camera of the land vehicle, the reference speed being estimated taking into account these speed values.

It should be noted that the features and measures listed individually in the following description can be combined with one another in any technically expedient manner and demonstrate further embodiments of the invention. The description additionally characterizes and specifies the invention, in particular in conjunction with the figures.

The reference speed may also be, and is hereinafter, referred to as the true speed. According to the invention, four speed values are used to estimate the true ground speed of the land vehicle. In this way, deviations of the individual speed values from the true ground speed of the land vehicle due to driving conditions and/or environmental conditions can be compensated for very well. The method according to the invention can therefore provide a significantly more accurate estimation of the true ground speed of the land vehicle. This is particularly advantageous in borderline situations, for example when cornering on snow, ice or the like. The problem here is that one or more wheels deviate significantly from the “true” speed. This can be caused by a large wheel slip ratio due to braking or driving forces. By more accurately estimating the true ground speed of the land vehicle, driving assistance systems of the land vehicle, such as an anti-lock braking system (ABS) and a traction control system (TCS), can be operated using a more accurate estimate, greatly improving the performance of such a system.

The invention advantageously improves the estimation of a ground reference speed of a land vehicle, in particular an electrically drivable land vehicle especially in borderline situations with wheel speeds that deviate significantly from the norm, such as understeer or oversteer or torque vectoring, braking interventions or drive system interventions.

The method according to the invention is used in particular for estimating a true ground speed of an electrically drivable land vehicle by means of the vehicle's own evaluation electronics, i.e. a hybrid electric vehicle or an electric vehicle. Alternatively or additively, the method according to the invention can also be used for land vehicles with a conventional drive, i.e. with an internal combustion engine. The method according to the invention can be designed as a pure software solution, so that no additional components, in particular sensors, are required. Instead, existing sensors from series production can be used. The true ground speed of the land vehicle estimated in each case using the method according to the invention can be used as an internal reference speed for controlling various driving assistance systems. The various speed values can also be used for a plausibility check in order to reliably prevent speed values that deviate completely from reality from being disregarded. The method according to the invention can be realized by connecting artificial neural networks in series and in parallel.

In one embodiment of the method according to the invention, a fifth speed value can be determined on the basis of radar data from a radar unit of the land vehicle. This fifth speed value can also be used for a plausibility check and/or taken into account when estimating the true ground speed of the land vehicle.

In the context of the present invention, for example, the following limit situations can be defined:
the anti-lock braking system or the traction control system is active in the longitudinal direction of the vehicle;
the land vehicle has a yaw rate error in the lateral direction, i.e. the actual yaw rate of the land vehicle deviates from the yaw rate calculated with a linear single-track model; or
a combination of the two above-mentioned factors, and/or
torque vectoring, wherein in the case of torque vectoring the torque required for a particular axle is distributed asymmetrically in order to generate an additional yaw moment. This can result in one wheel being braked while the other wheel is accelerated.

The invention is based on the realization that electric drives of electrically drivable land vehicles can enable more precise control of both the driving and braking torque of a land vehicle in order to control the behavior of the vehicle in borderline situations. To exploit this potential of electric drives, an accurate estimate of the true ground speed of a land vehicle is required, which the present invention enables.

In addition, a more accurate estimation of the true ground speed of a land vehicle enables simplified ABS and TCS control, as well as more advanced vehicle dynamics control (ESC) and torque vectoring control. This is also reliably ensured with the present invention.

The first speed value is determined taking into account the current wheel speed of at least one vehicle wheel of the land vehicle. In the process, a curve compensation of wheel speeds can take place, whereby measured wheel speeds can be corrected with reference to a radius of a curve currently being navigated and the wheel speeds can be recalculated at a certain imaginary point of the land vehicle, preferably at the center of the front axle of the land vehicle.

The method can also include a step of estimating the nature of the surface currently being driven on, which makes it possible to determine whether the land vehicle is on ice, snow, sand, wet asphalt or dry asphalt. An artificial neural network can be used for this process step, in particular a three-layer artificial LSTM (long short-term memory) network. To determine the coefficient of friction, the acceleration of the vehicle body in the longitudinal direction of the vehicle, the acceleration of the vehicle body in the lateral direction of the vehicle, the acceleration of the vehicle body in the vertical direction of the vehicle, the vehicle mass, wheel braking torques, drive torques, filtered wheel accelerations, the yaw rate, a yaw rate error, an absolute acceleration vector (Euclidean norm vector of longitudinal and lateral acceleration), ABS and TCS yaw rate error flags and a steering wheel angle can be fed to the artificial neural network as inputs. The artificial neural network can output the friction value from 1 to 5, for example, where 1 stands for ice, 2 for snow, 3 for sand, 4 for wet asphalt and 5 for dry asphalt.

Furthermore, the method can have a step of determining a tire model, for which an artificial neural network can also be used. The artificial neural network can use a given torque of an electric drive of the land vehicle to determine four slip values. Using this and the curve-adjusted wheel speeds, four virtual wheel speeds can be determined that are ideally identical to the “real” vehicle speed, which compensate for the respective wheel slip that can be safely attributed to the motor torque or a braking torque. By using the artificial neural network, a model for estimating normal wheel forces, which is required for a conventional tire model, can be dispensed with. The aforementioned LSTM network can determine a friction value that serves as an input to this artificial neural network to adjust the amount of slip of the torque caused by the electric drive. The type of road surface generally indicates what type of friction it has. One function of this network is to compensate for weight displacement and any kinematic effects in the suspension. The artificial neural network can have two layers and 36 parameters for this purpose. The purpose of this network is to underestimate the slip ratio (when the vehicle accelerates, the speed is less than or equal to the actual speed, and when the vehicle brakes, the speed is greater than or equal to the actual speed). The purpose of this procedure is to always have a safety factor. For example, if too high a slip ratio is estimated in a braking scenario (i.e. excessively low wheel speeds), the brake pressure could be erroneously reduced, reducing braking performance. This safety factor is achieved by rescaling the network outputs so that 95% of the data set is underestimated.

The artificial neural network can also be used to determine a tire characteristic. The acceleration of the vehicle body in the vehicle longitudinal direction, the acceleration of the vehicle body in the vehicle lateral direction, the acceleration of the vehicle body in the vehicle vertical direction, the vehicle mass, wheel braking torques and drive torques can be used as inputs for this. The artificial neural network can output the slip ratio for each wheel caused by an input torque and a current dynamic weight distribution.

The second speed value is determined taking into account the longitudinal acceleration of the land vehicle. The longitudinal acceleration can be integrated over time in order to obtain the second speed value. The longitudinal acceleration of the land vehicle can be measured by means of a longitudinal acceleration sensor or by means of an inertial measuring unit of the land vehicle. The longitudinal acceleration signal generated in this way becomes useless for estimating the true ground speed of the land vehicle in two situations, namely on inclines, where a longitudinal acceleration sensor measures a component of gravity, and in borderline situations in which a vehicle body of the land vehicle is exposed to large float angles (inclination of the body) and thus the longitudinal acceleration sensor measures a component of lateral acceleration. To recognize this, the longitudinal acceleration signal can be fed to an artificial neural network that can recognize both of the aforementioned situations and remove unwanted components from the measured longitudinal acceleration signal. The resulting adjusted/compensated longitudinal acceleration signal can then be fed to the above-mentioned time integration to determine the second velocity value. The artificial neural network can, for example, be a three-layer GRU (Gated Recurrent Unit) network. For this purpose, the acceleration of the vehicle body in the vehicle longitudinal direction, the acceleration of the vehicle body in the vehicle lateral direction, the acceleration of the vehicle body in the vehicle vertical direction, a steering wheel angle, filtered wheel accelerations, the yaw rate, a yaw rate error and a wheel speed, which has preferably been corrected by the tire model described above, can be fed to the artificial neural network as inputs. The artificial neural network can then determine an offset of the longitudinal acceleration signal and output a difference between the measured longitudinal acceleration and the offset as the longitudinal acceleration signal.

However, when integrating the acceleration over longer periods of time, an integration error builds up, making the signal increasingly inaccurate. For this reason, the approach according to the invention resets the integrator to a known good value as often as possible. During an ABS braking operation, the pressure in the brakes is partially reduced. When the pressure on a wheel brake is reduced, the tire recovers from slip and quickly approaches the actual vehicle speed. This is used according to the invention to reset the reference speed to a value close to the real vehicle speed. This value is the slip-adjusted value (which is therefore even closer to the real speed than the speed measured at the wheel). According to the invention, a wheel stability monitor, preferably in the form of a neural network, is used for this purpose. This monitors each individual wheel and evaluates its stability. Thus, if the brake is released during an ABS event, the stability index of this wheel is briefly high, which makes it advantageously possible to reset the integrator.

This network works not only for ABS and TCS, but also for longer borderline behavior, e.g. when the vehicle is skidding, alternating between left and right turns, with possible ABS and TCS events in between. It recognizes the brief moments when a wheel is rolling freely and close to the “real” vehicle speed and can be used to reset the integrator, which is useful in the traction control case for an all-wheel drive vehicle (as there are no non-drive wheels, there is positive slip on all four wheels, so there are no non-slip wheels to reference).

The third speed value is determined taking into account the GPS data received. Due to the limitations of the GPS hardware installed in the vehicle, the GPS signal can have a delay of 1 second and an update rate of 1 Hz even under normal conditions. However, the GPS signal can be improved with the help of compensated acceleration. Using GPS data as a speed source, for example, has the advantage that, if available, torque cut-offs on the land vehicle's wheels during ABS intervention and TCS intervention are no longer necessary because the reset of the compensated acceleration integrator is not performed by momentary torque cut-offs but via the one-second latency-compensated GPS data, which improves the land vehicle's performance, for example by shortening the land vehicle's braking distance during emergency braking. Compared to other dead reckoning algorithms, the GPS algorithm has the advantage that it can take into account wheel speeds and torques of an electric drive as well as a yaw rate error due to longitudinal acceleration compensation as inputs. The third speed value can be determined on the basis of dead reckoning using the output of the longitudinal acceleration compensation described above.

The fourth speed value is determined using camera data from a land vehicle camera.

Inputs of the method can be, for example, wheel speeds of one or more, in particular all, wheels of the land vehicle, torques of an electric drive of the land vehicle, acceleration values of a 3-axis accelerometer, in particular an inertial measuring unit, of the land vehicle, certain vehicle parameters, such as an estimated vehicle mass, GPS data, camera data or camera-supported speed data. In addition, signals from ride height sensors of the land vehicle and/or radar-based speed data or radar data from a radar unit of the land vehicle can be used as inputs of the method. The respective input can be normalized. For example, a wheel acceleration can be normalized using the wheel inertia. Alternatively, the parameters can be fed into an artificial neural network. For example, the vehicle mass can be included in the tire properties. This approach ensures that data from different land vehicles can be used when the model is applied to a new land vehicle, significantly increasing the size of the database and requiring less data collection during the application time.

According to an advantageous embodiment, a current driving state of the land vehicle is determined, with the speed values being weighted when estimating the true speed, taking the driving state into account. The four speed values can be combined to a certain extent in the form of different estimated true ground speeds of the land vehicle to form the final estimated true ground speed of the land vehicle. The final estimated true ground speed of the land vehicle provided by the method according to the invention, or the corresponding speed signal, can be smoothed to provide a better control signal as an input signal for drive and/or brake control units of the land vehicle. The weighting of the individual input signals or speed values depends on the driving status of the land vehicle, for example whether it is braking, accelerating (positively), the land vehicle is rolling freely, there is a yaw rate error or similar, as well as on the signal quality and the availability of the input signals. Geofencing (tunnel/city) can also be taken into account for the weighting of the third speed value determined from GPS data. The weather and/or time of day can also be taken into account when weighting the fourth speed value determined from the camera data. The same applies to a possible fifth speed value, which is determined from radar data.

A weighting between integrator and wheel speeds is proposed as follows
A distinction is made between cases with:
A. strong longitudinal and low lateral dynamics (TC and ABS events)
B. and any other driving style (mainly lateral dynamics and ESC events)
C. free rolling

With low wheel slip or even free rolling, the estimation of the wheel speeds is dominant and the integrator is more or less inactive (constant resetting).

In case A, the speed, which is determined from the wheel speed, is usually given very little weight, but can still be used for upper and lower limit values. For example, when braking, the wheel speed acts as a lower limit value, i.e. as a kind of safety net. Even if the wheel speed estimate becomes less accurate in these scenarios, it still retains a low weight to reduce the integration drift. During the torque interruption phases in ABS or TCS intervention, the wheel stability is high and vehicle speed determined from wheel speed is weighted at 90%. The remaining speed sources are given a maximum weighting based on the number of sources minus the wheel speeds (e.g. 4 sources in total->33%), but can be over weighted based on their base performance and reduced to 0 during poor operation (GPS in a tunnel, camera at high speed).

In case B, the preferred weighting is as follows:

The weighting between the speed determined from the wheel speed and the speed due to longitudinal acceleration is preferably the same if the wheels are unstable. The weighting is shifted up to 100% to the speed determined from the wheel speeds, based on the highest stability index of the four wheels. If the maximum index is 1, the weighting is shifted to 100% because one of the wheels has the real vehicle speed. Additional speed sources are given a maximum weight based on the number of sources (4 sources->25%), but can be over weighted based on their base performance, and their weight is reduced to 0 if they perform poorly (GPS in a tunnel, camera at high speed)

In case C, the preferred weighting is as follows:
The speed determined from the wheel speed is weighted at 100%.

Regarding the weighting of GPS

The weighting of GPS would then be reduced on the basis of the connection quality and/or the geofencing. In cities with many tall buildings, in tunnels, areas with lots of foliage, etc., the weighting is therefore significantly reduced or even set to 0.

The camera-based speed is particularly accurate at low speeds and is switched on and off depending on the speed.

According to a further advantageous embodiment, an optimum wheel speed is determined from instantaneous speeds of various wheels of the land vehicle, taking into account the instantaneous driving state of the land vehicle, in order to determine the first speed value. Exemplary instantaneous driving states can be (positive) acceleration, deceleration or the absence of longitudinal torque.

According to a further advantageous embodiment, it is determined which wheel is in a stable driving state, with the second speed value being determined at regular time intervals, taking into account the current speed of the wheel that is in a stable driving state. An artificial neural network can be used for this purpose, which monitors each individual wheel and can determine whether the particular wheel is currently experiencing slip or is stable. A stable driving state of a wheel is understood here to be a state in which the wheel rolls either freely or with applied torque and low resulting slip. The artificial neural network can generate a separate stability index here for each wheel, which indicates the probability that the wheel is currently in a stable state. The artificial neural network can be a three-layer GRU network, for example. The integrator used to integrate the longitudinal acceleration can be reset at regular time intervals to the second speed value, which has been determined taking into account the wheel speed of a wheel in a stable driving state. The adjusted/compensated acceleration of the vehicle body in the vehicle longitudinal direction, the acceleration of the vehicle body in the vehicle lateral direction, the acceleration of the vehicle body in the vehicle vertical direction, the vehicle mass, wheel braking torques, drive torques, filtered wheel accelerations, the yaw rate, a yaw rate error, an absolute acceleration vector (Euclidean norm vector of longitudinal and lateral acceleration), ABS and TCS flags, a steering wheel angle, an accelerator pedal position, a friction coefficient described above, a wheel speed, which has preferably been corrected by the tire model described above, and an average wheel speed can be fed to the artificial neural network. The artificial neural network can output a separate wheel stability index for each wheel, which can lie in a range from 0 to 1.

According to a further advantageous embodiment, a curve compensation of input data takes place when determining the first speed value and the second speed value.

According to a further advantageous embodiment, the longitudinal acceleration of the land vehicle is integrated to determine the third speed value, taking into account a transmission delay of GPS signals. The GPS signals are used as a reference for resetting the integrator. The GPS signal is characterized by a low sampling rate and large transmission delays (e.g.: 1 Hz and 1 second delay). This transmission delay can be overcome by adding the longitudinal acceleration compensation described above during the delay time, so that as soon as a new value corresponding to t−1 is available, this buffer can be used to calculate the speed at the current time t. So when an updated value is received from the GPS, this value corresponds to the speed of 1 second ago (i.e. tnow−1 second or time step). Since it is known what the speed was one second ago, there is a solid reference from which to integrate. As already described above, the biggest problem with acceleration compensation and subsequent integration is that errors accumulate over long periods of integration and the signal begins to drift, so the wheel stability must be monitored so that the integrator can be reset as often as possible. With GPS, as described, a reset point for the integrator is obtained every second. However, this reset point is one second in the past, so the compensated acceleration values are stored in a buffer for one second, and once a new GPS value is obtained, integration is performed from this point using the stored values, providing an estimation of the current speed.

The forward integration of the longitudinal acceleration then takes place using the current values of the longitudinal acceleration compensation and generates a speed signal with an update rate that corresponds to that of the speed signals for the first speed value and the second speed value.

According to a further advantageous embodiment, the fourth speed value is determined taking into account camera data from a rear camera of the land vehicle, with an optical flow being determined from the camera data and the fourth speed value being determined taking into account the optical flow. The use of the rear camera, in particular the reversing camera, is therefore advantageous because many land vehicles are already equipped with such a rear camera, so that no additional camera needs to be installed. When determining the fourth speed value, the above-mentioned output signals from artificial neural networks can be used to support computer vision algorithms. In the case of such an algorithm for determining an optical flow, this can be used, for example, to adjust the size, shape and position of a search window. The fourth speed value can be determined in two stages. In the first stage, the camera images can be used as input and the optical flow can be determined from them, wherein either energy-based models (e.g.: Farneback) or deep learning methods can be used, and a pixel-wise u,v vector is output. The second stage takes the output of the first stage, the camera input, corrected wheel speeds, inputs generated by an inertial measurement unit, steering wheel angles, etc. as inputs for an artificial neural network, in particular a convolutional artificial neural network with LSTM head, which outputs the fourth speed value. The artificial neural network can therefore compensate for the vehicle movement instead of doing this in post-processing. In addition, a confidence interval can be generated for the first stage in order to be able to deactivate the generation of the fourth speed value depending on weather conditions, lighting conditions and/or obstacles in front of the camera.

In a further aspect of the invention, a land vehicle is disclosed, the evaluation electronics of which is set up to carry out the method according to one of the above-mentioned embodiments or a combination of at least two of these embodiments with one another.

### BRIEF DESCRIPTION OF THE DRAWINGS

Further advantageous embodiments of the invention are disclosed in the dependent claims and the following description of the figures, in which:

FIG. 1 shows a block diagram of an exemplary embodiment of a method according to the invention;

FIG. 2 shows a block diagram of details of the method shown in FIG. 1; and

FIG. 3 shows an implementation of the method according to the invention in a software structure of a land vehicle.

In the various figures, the same parts are always provided with the same reference signs, which is why they are generally also only described once.

### DETAILED DESCRIPTION

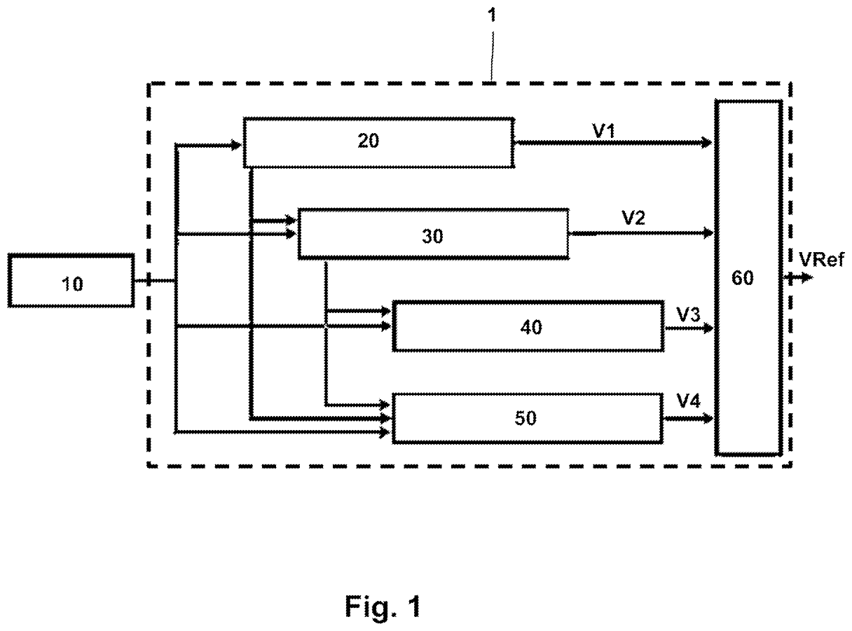

FIG. 1 shows a block diagram of an exemplary embodiment of a computer-implemented method 1 according to the invention for estimating a true ground speed VRef of a land vehicle, in particular an electrically drivable land vehicle, by means of the vehicle's own evaluation electronics, which may comprise computer hardware and software, wherein the software include instructions that when executed buy a the computer hardware (e.g., a processor) causes the steps and functionalities described herein.

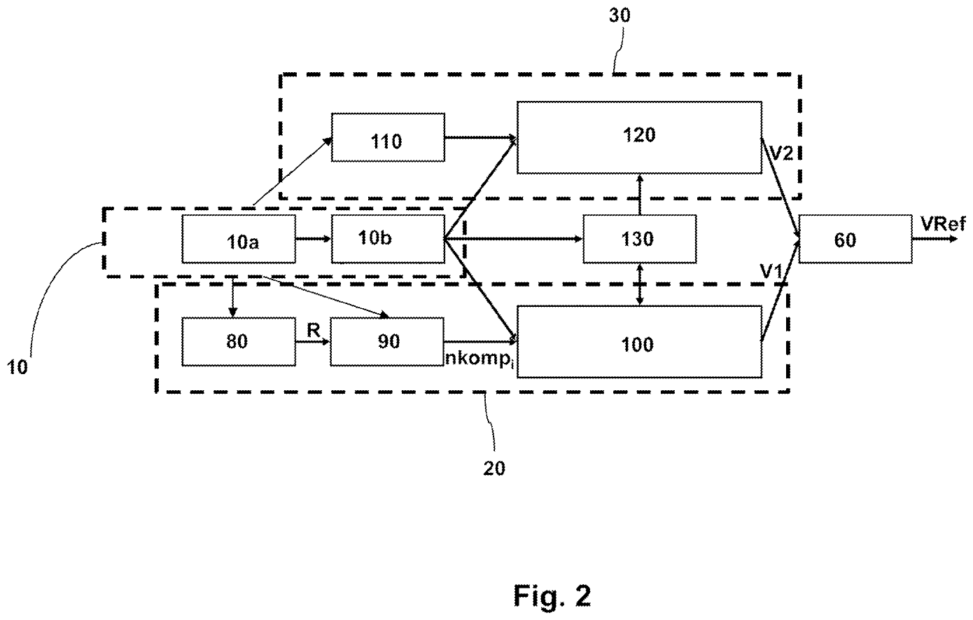

Block 10, which consists of the blocks 10a and 10b visible in FIG. 2, contains inputs and curve compensations of wheel speeds, on the basis of which a first speed value V1 is calculated in block 20, taking into account an instantaneous wheel speed of at least one vehicle wheel of the land vehicle, a second speed value V2 is determined in block 30, taking into account a longitudinal acceleration of the land vehicle, a third speed value V3 is determined in block 40, taking into account received GPS data, and a fourth speed value V4 is determined in block 50, taking into account camera data from a camera of the land vehicle. The true speed VRef is estimated taking into account these speed values V1 to V4. The outputs of block 20 are also fed to the blocks 30 and 50. The outputs of block 30 are fed to the blocks 40 and 50.

The inputs according to block 10a can include outputs of an inertial measuring unit of the land vehicle, namely the acceleration signals with respect to the three spatial dimensions and the yaw rate, wheel speeds, torques of an electric drive of the land vehicle, friction brake torques, camera data of a rear camera of the land vehicle and the like.

In block 60, the speed values V1 to V4 are weighted and combined when estimating the true speed VRef, taking into account a determined current driving state of the land vehicle.

FIG. 2 shows a block diagram of details of the method shown in FIG. 1.

In block 10b, a curve compensation of wheel speeds takes place, with the particular wheel speed being compensated in dependence on a radius of an instantaneous cornering movement. The curve-compensated wheel speeds are then fed to the blocks 20 and 30. In addition, the wheel speeds can be recalculated in block 10b at a specific imaginary point on the land vehicle, preferably at the center of the front axle of the land vehicle.

In block 80, the condition of the surface currently being driven on is determined. In particular, it is determined here whether the land vehicle is currently on ice, snow, sand, wet asphalt or dry asphalt. An artificial neural network can be used for this method step, in particular a three-layer artificial neural LSTM (long short-term memory) network.

The artificial neural network can determine a friction coefficient R. For this purpose, the acceleration signals relating to the three spatial dimensions, the vehicle mass, friction brake torques, drive torques, filtered wheel accelerations, the yaw rate, a yaw rate error, an absolute acceleration vector (Euclidean norm vector of longitudinal and lateral acceleration), ABS and TCS flags and a steering wheel angle can be fed to the artificial neural network as inputs. The artificial neural network can output the friction value R from 1 to 5, for example, wherein 1 stands for ice, 2 for snow, 3 for sand, 4 for wet asphalt and 5 for dry asphalt.

In block 90, another artificial neural network is used to map tire characteristics that can be combined to form a tire model. For this purpose, the acceleration signals relating to the three spatial dimensions, the vehicle mass, friction brake torques and drive torques can be fed to the artificial neural network as inputs. The artificial neural network can output the slip ratio for the respective vehicle wheel, which is caused by a drive torque or a braking torque on the one hand and a current dynamic weight distribution of the land vehicle on the other. This enables the artificial neural network to determine a virtual wheel speed nkompᵢ for each vehicle wheel, which compensates for the particular wheel slip. This artificial neural network can be a two-layer artificial neural network. Braking torques can be caused either by the friction brake ((friction) braking torque) or the electric motors.

In block 90, the wheel speeds can also be compensated in dependence on the known engine torques generated by the electric drive, since the respective wheel slip is caused by the engine torques. The invention is based here on the realization that estimating the torque of electric motors is much more accurate than estimating the torque of an internal combustion engine and the friction brakes.

The virtual wheel speeds nkompᵢ are then fed to block 100. In block 100, the wheel speed that best matches the current driving situation or the current driving status of the land vehicle is selected from several wheel speeds. A maximum wheel speed can be selected here when the land vehicle is performing a braking operation. On the other hand, a minimum wheel speed can be selected when the land vehicle is performing a (positive) acceleration operation. In addition, an average value can be formed from the various wheel speeds and selected when the land vehicle is rolling freely. Lastly, the first speed value V1 is generated and output in block 100, more specifically taking into account the wheel speed selected in block 100.

In block 110, longitudinal acceleration signals are compensated. This is necessary because the longitudinal acceleration signal is not directly suitable for integration into a speed under certain conditions. In particular, a longitudinal acceleration sensor measures a component of gravity that distorts the longitudinal acceleration signal when a land vehicle is on an incline/decline. In addition, the longitudinal acceleration sensor measures a component of lateral acceleration if the vehicle body of the land vehicle is exposed to large float angles. This also distorts the longitudinal acceleration signal. In order to be able to recognize these distortions, the longitudinal acceleration signal in block 110 is fed to another artificial neural network that can recognize the two aforementioned situations and remove distorting components from the longitudinal acceleration signal. The adjusted or compensated longitudinal acceleration signal obtained in this way is then fed to block 120, in which the longitudinal acceleration signal is integrated over time in order to obtain the second speed value. The artificial neural network from block 110 can, for example, be a three-layer GRU (Gated Recurrent Unit) neural network. For this purpose, the acceleration signals with respect to the three spatial dimensions, a steering wheel angle, filtered wheel accelerations, a yaw rate, a yaw rate error and a wheel speed, which has preferably been corrected by the tire model described above, can be fed to the artificial neural network as inputs.

In block 130, it can be determined for each vehicle wheel whether the vehicle wheel is experiencing slip or is in a stable driving state or rolling state. A further artificial neural network can be used for this purpose. A stable driving state of a particular wheel is understood to be a state in which the wheel rolls either freely or with applied torque and low slip resulting from the torque. The artificial neural network can generate a separate confidence value for each wheel, which indicates the probability that the wheel is currently in a stable state. The artificial neural network can be a three-layer GRU network, for example. The integrator used to integrate the longitudinal acceleration in block 120 can be reset at the regular time intervals to the second speed value, which has been determined taking into account the wheel speed of a wheel in a stable driving state. The compensated acceleration signal from block 110, the vehicle mass, wheel braking torques, drive torques, filtered wheel accelerations, a yaw rate, a yaw rate error, ABS and TCS flags, a steering wheel angle, an acceleration pedal position, a friction value from block 80 described above, a wheel speed nkompᵢ and an average wheel speed can be fed to the artificial neural network from block 130 as inputs. The artificial neural network can output a separate wheel stability index for each wheel, which can lie in a range from 0 to 1.

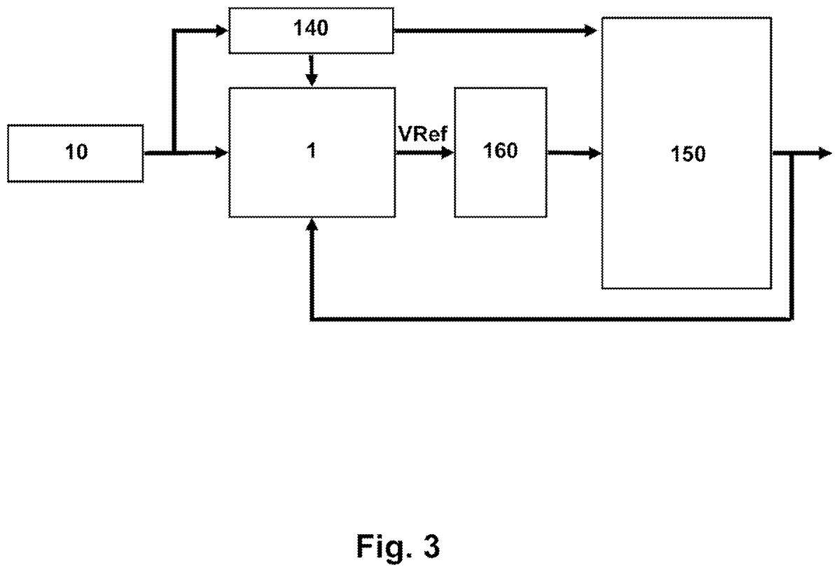

FIG. 3 shows an implementation of the method 1 according to the invention in a software structure of a land vehicle.

The inputs and curve compensations of wheel speeds from block 10 are additionally fed to an ABS and TCS flag unit 140, the outputs of which are fed to the method 1 and a wheel slip controller 150. A wheel slip which has been determined in block 160 using the true ground speed of the land vehicle estimated by the method 1 is also fed to the wheel slip controller 150. The wheel slip controller 150 outputs wheel torque signals, which are also fed to the method 1.

### LIST OF REFERENCE SIGNS

1 method
10-160 method blocks
nkompᵢ compensated wheel speed
R friction value
V1 first speed value
V2 second speed value
V3 third speed value
V4 fourth speed value
VRef true speed

We claim:

1. A computer-implemented method for estimating a true ground speed of a land vehicle, comprising:
determining a first speed value taking into account an instantaneous wheel speed of at least one vehicle wheel of the land vehicle;
determining a second speed value taking into account a compensated longitudinal acceleration of the land vehicle;
determining a third speed value taking into account received GPS data; and
determining a fourth speed value taking into account camera data of a camera of the land vehicle; and
estimating the true speed taking into account the first, second, third and fourth speed values.

2. The method of claim 1, further comprising:
determining a current driving state of the land vehicle, wherein the first, second, third and fourth speed values are weighted when estimating the true speed, taking the driving state into account.

3. The method of claim 1, further comprising:
determining an optimum wheel speed from instantaneous speeds of different wheels of the land vehicle.

4. The method of claim 1, wherein the second speed value is determined by integrating the compensated longitudinal acceleration over time.

5. The method of claim 1, further comprising:
determining which wheel is in a stable driving state, with the second speed value being reset at regular intervals, taking into account the current speed of the wheel that is in a stable driving state.

6. The method of claim 1, wherein a curve compensation of wheel speeds takes place when determining the first speed value and the second speed value.

7. The method of claim 1, wherein the longitudinal acceleration of the land vehicle is integrated to determine the third speed value (V3), with a transmission delay of GPS signals being taken into account.

8. The method of claim 1, wherein the fourth speed value is determined taking into account camera data from a rear camera of the land vehicle, with an optical flow being determined from the camera data and the fourth speed value taking into account the optical flow.

9. The method of claim 1, wherein at least one of the first, second, third or fourth speed values is determined using an artificial neural network.

10. A vehicle for estimating a true ground speed of a land vehicle, comprising:
evaluation electronics, wherein the evaluation electronics are configured to perform the following steps:
determining a first speed value taking into account an instantaneous wheel speed of at least one vehicle wheel of the land vehicle;
determining a second speed value taking into account a compensated longitudinal acceleration of the land vehicle;
determining a third speed value taking into account received GPS data; and
determining a fourth speed value taking into account camera data of a camera of the land vehicle; and
estimating the true speed taking into account the first, second, third and fourth speed values.

11. The vehicle according to claim 10, wherein the evaluation electronics are further configured to perform the step of:
determining a current driving state of the land vehicle, wherein the first, second, third and fourth speed values are weighted when estimating the true speed, taking the driving state into account.

12. The vehicle according to claim 10, wherein the evaluation electronics are further configured to perform the step of:
determining an optimum wheel speed from instantaneous speeds of different wheels of the land vehicle.

13. The vehicle according to claim 10, wherein the second speed value is determined by integrating the compensated longitudinal acceleration over time.

14. The vehicle according to claim 10, wherein the evaluation electronics are further configured to perform the step of:
determining which wheel is in a stable driving state, with the second speed value being reset at regular intervals, taking into account the current speed of the wheel that is in a stable driving state.

15. The vehicle according to claim 10, wherein a curve compensation of wheel speeds takes place when determining the first speed value and the second speed value.

16. The vehicle according to claim 10, wherein the longitudinal acceleration of the land vehicle is integrated to determine the third speed value (V3), with a transmission delay of GPS signals being taken into account.

17. The vehicle according to claim 10, wherein the fourth speed value is determined taking into account camera data from a rear camera of the land vehicle, with an optical flow being determined from the camera data and the fourth speed value taking into account the optical flow.

18. The vehicle according to claim 10, wherein at least one of the first, second, third or fourth speed values is determined using an artificial neural network.
